(19) United States
(12) Patent Application Publication
(10) Pub. No.: US 2006/0095504 A1
(43) Pub. Date: May 4, 2006

(54) System and method for optical character information retrieval (OCR) via a thin-client user interface

(76) Inventor: Jonathan Ian Gelsey, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/925,829

(22) Filed: Aug. 24, 2004

(51) Int. Cl. G06F 15/16

(52) U.S. Cl. 709/203

(57) ABSTRACT

A method and system for allowing optical character recognition (OCR) information retrieval via a thin-client user interface. The method includes receiving an information request from a user via a thin-client user interface, where the information request is an image. Next, optical character recognition is performed on the image to produce a string. A data network is then searched to extract content based on the string. Finally, the extracted content is displayed to the user.

### BACKGROUND

The importance of the ability to access on-line information (e.g., via the Internet or an internal server) cannot be overstated. This is especially true today where person to person customer service seems to be a thing of the past. The ability for most people to access on-line information with ease is assumed by the majority of information providers. Unfortunately, this is not always the case.

One common storage area for on-line information is the Internet. One method of accessing information on the Internet is known as the World Wide Web (www, or the “web”). The web is a distributed, hypermedia system, and functions as a client-server based information presentation system. Information that is intended to be accessible over the web is stored in the form of “pages” on general-purpose computers known as “servers.” The most common way for a user to access a web page is by using a personal computer (e.g., laptop computer, desktop computer, etc.), referred to as “client”, to specify the uniform resource locator (URL) of the page web for which he or she wishes to view.

There are many reasons why the use of a personal computer via a keyboard to access on-line information is not desireable. One reason is that the use of a personal computer to access on-line information is not possible if the user does not have access to such a computer. Additionally, not everyone has the ability or desire to use a personal computer to access on-line information. This lack of ability or desire could be due to the lack of skill in the use of a keyboard of the personal computer, the lack of knowledge on how the computer itself operates, the lack of knowledge on how to make a search or request for the desired information, and so forth. In the case where the on-line information needs to be retrieved quickly, there may be no time to wait for a computer to boot up, etc.

Many users are not good at determining the most relevant keywords or phases to conduct a search for on-line information in order to receive relevant responses to their requests. Here, it becomes frustrating when either the user has to review many non-relevant responses to his or her request or has to keep reexecuting the same request for information, but in a different way, until the appropriate results are returned.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for an optical character recognition (OCR) information retrieval system in which some embodiments of the present invention may operate;

FIG. 2 illustrates one embodiment of the OCR information retrieval system in which some embodiments of the present invention may operate;

FIG. 3 is a flow diagram of one embodiment of a process for optical character recognition (OCR) information retrieval via a thin-client user interface;

FIG. 4 is a flow diagram of one embodiment of a process for a user making an information request via a thin-client user interface (step 302 of FIG. 3); and

FIG. 5 is a flow diagram of one embodiment of a process for processing the information request by the OCR information retrieval system to produce the requested information (step 304 of FIG. 3).

### DESCRIPTION OF EMBODIMENTS

A method and system for allowing optical character recognition (OCR) information retrieval via a thin-client user interface are described. In the following description, for purposes of explanation, numerous specific details are set forth. It will be apparent, however, to one skilled in the art that embodiments of the invention can be practiced without these specific details.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and hardware components.

Thus, a machine-readable medium may include any mechanism for storing or transmitting information in a form readable by a machine (e.g., a computer). These mechanisms include, but are not limited to, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments.

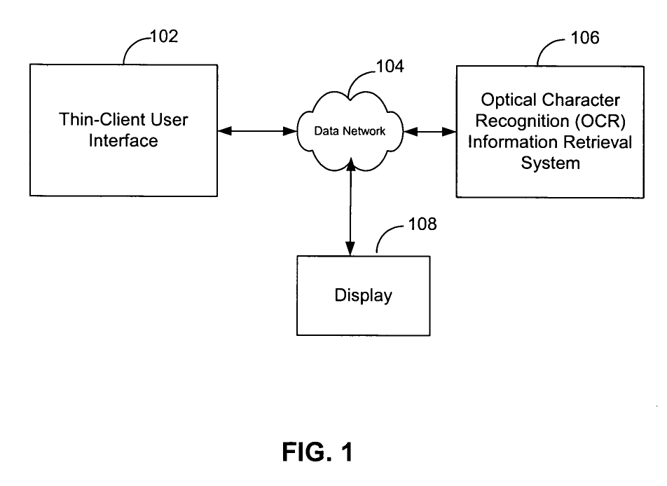

FIG. 1 illustrates one embodiment of an environment for allowing optical character recognition (OCR) information retrieval via a thin-client user interface, in which some embodiments of the present invention may operate. The specific components shown in FIG. 1 represent one example of a configuration that may be suitable for the invention and is not meant to limit the invention.

Referring to FIG. 1, the environment for an OCR information retrieval system includes, but is not necessarily limited to, a thin-client user interface 102, a data network 104, an OCR information retrieval system 106 and a display 108. At a high level and in an embodiment of the invention, a user utilizes thin-client user interface 102 to make an information request. The information request is forwarded via data network 104 to OCR information retrieval system 106. System 106 processes the information request to produce the requested information for the user. Once system 106 processes the information request to produce the requested information for the user, the requested information is displayed for the user on display 108. Each of these components is described in more detail next.

In an embodiment of the invention, thin-client user interface 102 is a pad of paper with the ability to track a pen tip. The pen tip is used to capture what a user writes on the pad of paper (i.e., the user's information request). The writing is then interpreted into an image. The pen tip may incorporate, but is not limited to, ultrasound-based tracking, infrared-based tracking, or visible spectrum-based tracking, all of which technologies are well known in the art. Other types of tracking may be added or substituted for those described as new types of tracking are developed. In another embodiment of the invention, thin-client user interface 102 may be a personal digital assistant (PDA).

The pad of paper of thin-client user interface 102 may be general or specialized. If the pad of paper is specialized, then the user is required to enter his or her information request in a predefined manner. For example, assume that the pad of paper is specialized to retrieve telephone numbers (e.g., a phone directory pad of paper). The user may be required to enter a person's name onto the pad of paper with the person's first name followed by his or her last name and city of residence (e.g., Joe Smith, Chicago). Since the pad of paper is specialized, the invention understands exactly the information being requested by the user and searches specialized directories/servers for the information. Here, it is more likely that the search remains local, but the invention is not limited to a local search. The invention may also search via the Internet or some combination of the Internet and a local search. The specialized phone directory example is used for illustration purposes only and is not meant to limit the invention. The pad of paper may be specialized to retrieve any type of information request.

If the pad of paper of thin-client user interface 102 is general, then the user may use it for any information request. For example, the user may enter the following information request with no predefined format, “Find the phone number for Joe Smith in Chicago.” Here, the invention must first determine what the information request is and search accordingly to provide the user with the requested information. Here, the search may be local, via the Internet, or some combination of both.

In an embodiment to the invention, the image generated by thin-client user interface 102 is sent to OCR information retrieval system 106 via data network 104. Data network 104 may be a local area network (LAN), a wide area network (WAN), any type of Wi-Fi or Institute of Electrical and Electronics Engineers (IEEE) 802.11 network (including 802.11a, 802.11b and dual band), the Internet, universal serial bus (USB), 1394, intelligent drive electronics (IDE), peripheral component interconnect (PCI) and infrared, or some combination of the above. Other types of networks may be added or substituted for those described as new types of networks are developed.

OCR information retrieval system 106 inputs the image from thin-client user interface 102 that represents an information request from a user. System 106 then performs optical character recognition on the image to extract the string written by the user. If the pad of paper of thin-client user interface 102 is general, OCR information retrieval system 106 determines the search criteria (e.g., keywords) based on the string, searches data network 104 for appropriate contents based on the search criteria, extracts the contents most relevant to the search criteria and forwards the extracted contents to the user. These extracted contents are displayed on display 108 to the user in response to his or her information request.

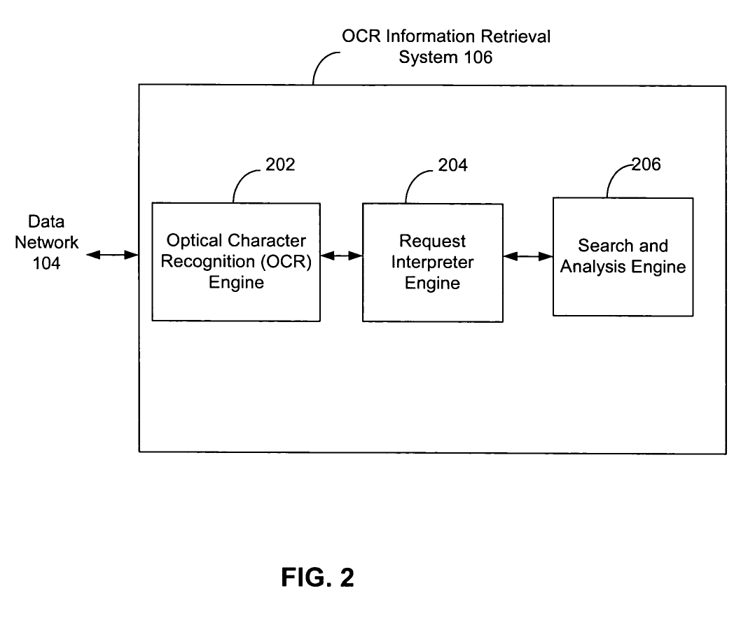

Display 108 may be any display component that includes, but is not limited to, a LCD display located next to the pad of paper, a computer system monitor, a television, and so forth. Display 108 may also be a PDA. Note that in the case of a PDA with its touch screen/display technology, the PDA may serve as both thin-client user interface 102 and display 108. An embodiment of the components of OCR information retrieval system 106 is described next with reference to FIG. 2.

Referring to FIG. 2, OCR information retrieval system 106 includes, but is not necessarily limited to, an OCR engine 202, a request interpreter engine 204 and a search and analysis engine 206. OCR engine 202 receives the user's information request in the form of an image. OCR engine 202 performs optical character recognition on the image to extract the string written by the user with thin-client user interface 102. In the case where the pad of paper is general, request interpreter engine 204 determines search criteria (e.g., keywords based on the string). Search and analysis engine searches data network 104 for appropriate contents, extracts the contents most relevant to the search criteria and sends the most relevant contents to display 108.

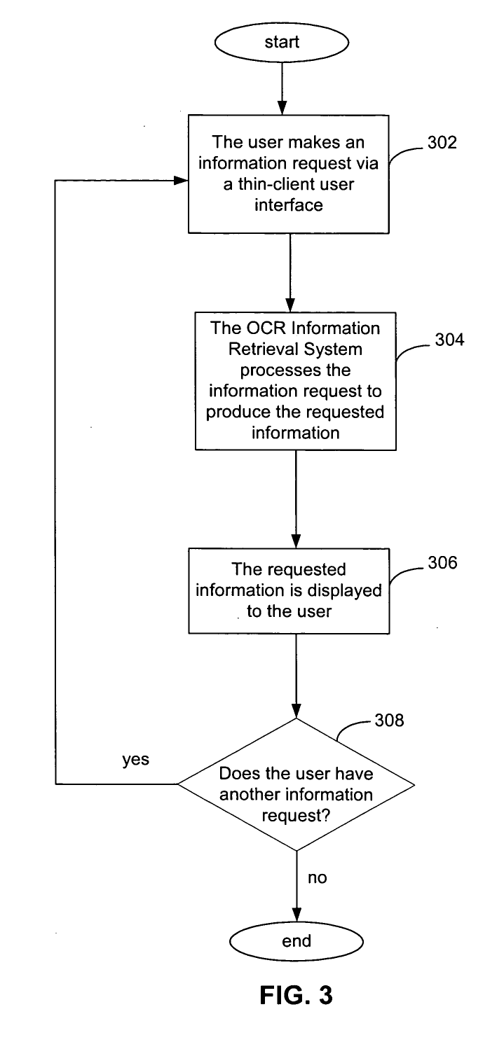

It is to be appreciated that a lesser or more equipped OCR information retrieval system 106 than the example described above may be preferred for certain implementations. Therefore, the configuration of system 106 will vary from implementation to implementation depending upon numerous factors, such as price constraints, performance requirements, technological improvements, or other circumstances. Embodiments of the invention may also be applied to other types of software-driven systems that use different hardware architectures than that shown in FIGS. 1 and 2. Embodiments of the operation of the present invention are described next in more detail with reference to the flow diagrams of FIGS. 3-5.

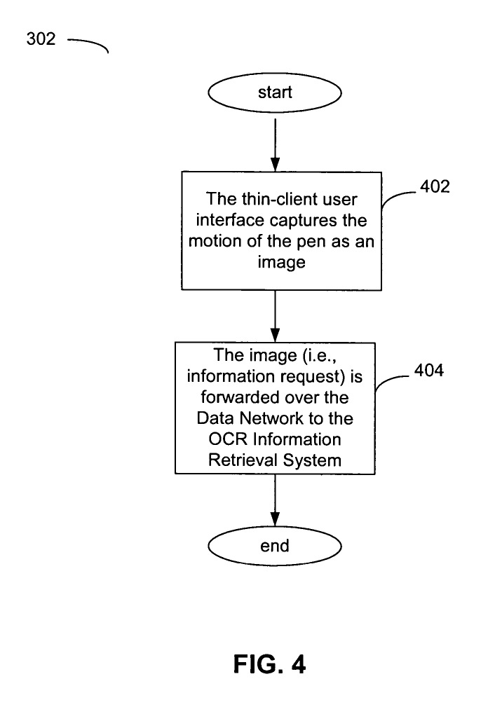

FIG. 3 is a flow diagram of one embodiment of a process for optical character recognition information retrieval via a thin-client user interface. Referring to FIG. 3, the process begins at processing block 302 with the user making an information request via thin-client user interface 102. As described above, the pad of paper of thin-client user interface 102 may be general or specialized. An example of an information request if the pad of paper is specialized is “Joe Smith, Chicago.” An example of an information request if the pad of paper is general is “Find the phone number for Joe Smith in Chicago.” Processing block 302 is described in more detail below with reference to FIG. 4.

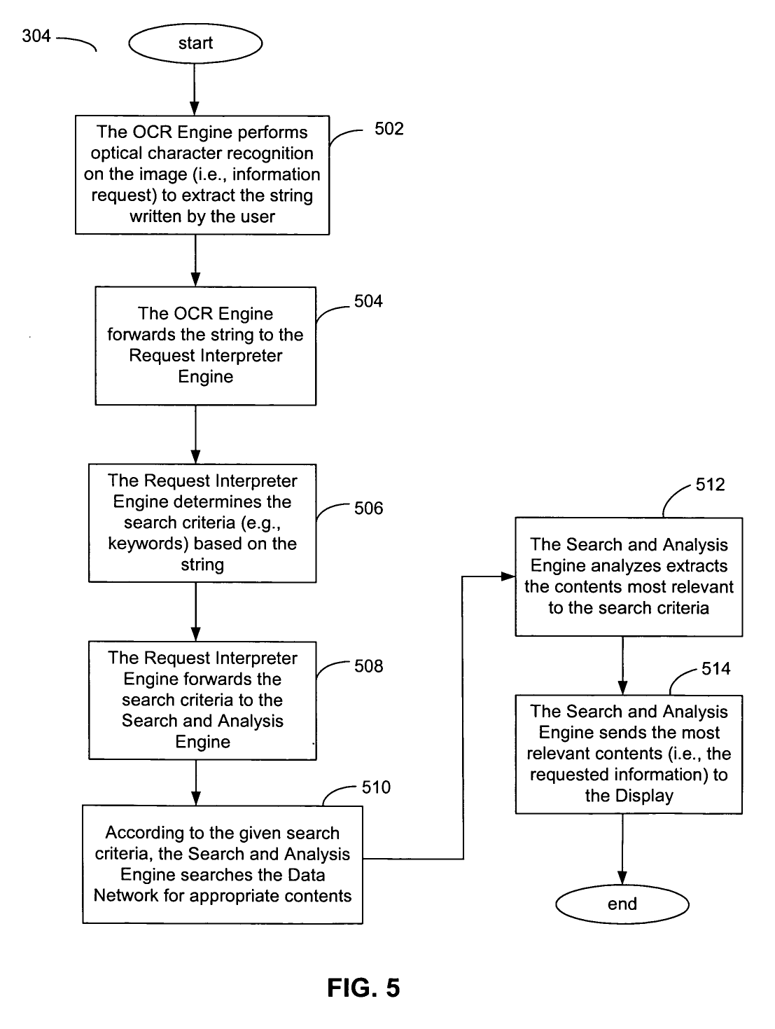

In processing block 304, OCR information retrieval system 106 processes the information request to produce the requested information. In the case where the pad of paper being specialized, OCR information retrieval system 106 receives the information request and understands exactly the information the user is requesting (provided that the information request was entered correctly by the user). Here, system 106 is likely to execute a local search by searching specialized directories/servers for the information. In the case where the pad of paper is general, processing block 304 is described in more detail below with reference to FIG. 5.

In processing block 306, the requested information is displayed to the user via display 108. At decision block 308, it is determined whether the user has another information request. If so, then processing logic proceeds back to processing block 302. Otherwise, the process of FIG. 3 ends at this point.

FIG. 4 is a flow diagram of one embodiment of a process for a user making an information request via a thin-client user interface (step 302 of FIG. 3). Referring to FIG. 4, the user writes his or her request on the pad of paper of thin-client user interface 102 in processing step 402. Thin-client user interface 102 captures the motion of the pen as an image. In processing step 404, the image (i.e., information request) is forwarded over data network 104 to OCR information retrieval system 106. The process of FIG. 4 ends at this point.

FIG. 5 is a flow diagram of one embodiment of a process for processing the information request by the OCR information retrieval system to produce the requested information when the pad of paper is general (step 304 of FIG. 3). Referring to FIG. 5, OCR engine 202 performs optical character recognition on the image (i.e., information request) to extract the string written by the user. Using the same example as above, the information request is “Find the phone number for Joe Smith in Chicago.”

At processing block 504, OCR engine 202 forwards the string to request interpreter engine 204. In processing block 506, request interpreter engine 204 determines the search criteria (e.g., keywords) based on the string. For example, the search criteria or keywords may include “phone number”, “Joe Smith” and “Chicago”.

At processing block 508, request interpreter engine 204 forwards the search criteria to search and analysis engine 206. In processing block 510, search and analysis engine 206 uses the search criteria to search data network 104 for appropriate contents. In our example, assume data network 104 is the Internet and that search and analysis engine 206 uses the keywords “phone number”, “Joe Smith” and “Chicago” to conduct a query search on the Internet. Also assume that the Internet search results in the following contents: (1) a listing of all of the phone numbers for Joe Smith in Chicago, Ill.; (2) a web site for a restaurant in Chicago, Ill. where Joe Smith is the owner and the web site includes the phone number for the restaurant; and (3) a listing for all of the phone numbers for Joe Smith living at the Chicago Housing Development in Pittsburgh, Pa.

At processing block 512, search and analysis engine 206 analyzes the contents (1)-(3) above. Search and analysis engine 206 then extracts the contents most relevant to the search criteria. In our example, search and analysis engine 206 is likely to determine that only content (1) above is relevant to the user's information request (i.e., search criteria).

Finally, in processing block 514, search and analysis engine 206 sends the most relevant content (i.e., the requested information) to display 108. Again, in our example, search and analysis engine 206 would send only content (1). The process of FIG. 5 ends at this point.

A method and system for allowing OCR information retrieval via a thin-client user interface have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
receiving an information request from a user via a thin-client user interface, wherein the information request is an image;
performing optical character recognition on the image to produce a string;
searching a data network to extract content based on the string; and
sending the extracted content to be displayed to the user.

2. The method of claim 1, wherein the thin-client interface is a pad of paper with the ability to track a pen tip.

3. The method of claim 2, wherein the ability to track a pen tip incorporates ultrasound-based tracking.

4. The method of claim 2, wherein the ability to track a pen tip incorporates infrared-based tracking.

5. The method of claim 2, wherein the ability to track a pen tip incorporates visible spectrum-based tracking.

6. The method of claim 1, wherein the thin-client interface is a personal digital assistant (PDA).

7. The method of claim 1, wherein the data network is the Internet.

8. The method of claim 1, wherein the data network is a local data network.

9. A system comprising:
a thin-client user interface that receives an information request from a user, wherein the information request is an image;
an optical character recognition (OCR) information retrieval system that performs optical character recognition on the image to produce a string, wherein the OCR information retrieval system searches a data network to extract content based on the string, and wherein the OCR information retrieval system sends the extracted content to be displayed to the user.

10. The system of claim 9, wherein the thin-client interface is a pad of paper with the ability to track a pen tip.

11. The system of claim 10, wherein the ability to track a pen tip incorporates ultrasound-based tracking.

12. The system of claim 10, wherein the ability to track a pen tip incorporates infrared-based tracking.

13. The system of claim 10, wherein the ability to track a pen tip incorporates visible spectrum-based tracking.

14. The system of claim 9, wherein the thin-client interface is a personal digital assistant (PDA).

15. The system of claim 9, wherein the data network is the Internet.

16. The system of claim 9, wherein the data network is a local data network.

17. A machine-readable medium containing instructions which, when executed by a processing system, cause the processing system to perform a method, the method comprising:
receiving an information request from a user via a thin-client user interface, wherein the information request is an image;
performing optical character recognition on the image to produce a string;
searching a data network to extract content based on the string; and
sending the extracted content to be displayed to the user.

18. The machine-readable medium of claim 17, wherein the thin-client interface is a pad of paper with the ability to track a pen tip.

19. The machine-readable medium of claim 18, wherein the ability to track a pen tip incorporates ultrasound-based tracking.

20. The machine-readable medium of claim 18, wherein the ability to track a pen tip incorporates infrared-based tracking.

21. The machine-readable medium of claim 18, wherein the ability to track a pen tip incorporates visible spectrum-based tracking.

22. The machine-readable medium of claim 17, wherein the thin-client interface is a personal digital assistant (PDA).

23. The machine-readable medium of claim 17, wherein the data network is the Internet.

24. The machine-readable medium of claim 17, wherein the data network is a local data network.
